(19) United States
(12) Patent Application Publication
(10) Pub. No.: US 2009/0098925 A1
(43) Pub. Date: Apr. 16, 2009

(54) Handheld Gaming Machines and System Therefor

(76) Inventors: Mark B. Gagner, West Chicago, IL (US); Shridhar P. Joshi, Naperville, IL (US); Larry J. Pacey, Northbrook, IL (US); Craig J. Sylla, Round Lake, IL (US); Matthew J. Ward, Northbrook, IL (US)

Correspondence Address: NIXON PEABODY LLP, 161 N CLARK ST., 48TH FLOOR, CHICAGO, IL, 60601-3213, US

(21) Appl. No.: 11/990,473

(22) PCT Filed: Aug. 14, 2006
(86) PCT No.: PCT/US2006/031969

§ 371 Date: Feb. 14, 2008

Related U.S. Application Data
(60) Provisional application No. 60/708,336, filed on Aug. 15, 2005.
(60) Provisional application No. 60/710,033, filed on Aug. 18, 2005.

(51) Int. Cl. A63F 9/24; A63F 13/00

(52) U.S. Cl. 463/20

(57) ABSTRACT

A gaming system for executing a wagering game includes a central server for storing game information. The system further includes a plurality of boundary controllers defining a permissible gaming area. The system includes at least one handheld gaming machine in communication with the central server, the handheld machine comprising a display for displaying the execution of a wagering game. The handheld gaming machine wirelessly communicates with one or more of the plurality of boundary controllers to permit the central server to activate the wagering game only when the handheld gaming machine is within the permissible gaming area.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to a handheld gaming machine and system.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

One problem that exists relates to the static layout of gaming machines within a casino or other operator. Because traditional gaming machines are relatively large and not mobile, players playing these machines spend. significant periods of time in only one area of a casino. This problem is compounded by the fact that a stationary player is less likely to see other portions of a casino and other gaming machines being offered therein, which creates a more challenging marketing scenario for a casino operator to encourage movement about the casino. Another problem exists in that given the fixed nature of the gaming machine, players who wish to socialize, eat, drink, or engage in other entertaining activities are required to leave the gaming machine to do so, thereby limiting their time playing the gaming machine, which is also disadvantageous to the casino operator. The handheld gaming machine and system of the present invention is directed to solving one or more of these and other problems.

### SUMMARY OF THE INVENTION

According to one aspect of the present invention, a gaming system for executing a wagering game includes a central server for storing game information. The system further includes a plurality of boundary controllers defining a permissible gaming area. The system includes at least one handheld gaming machine in communication with the central server, the handheld machine comprising a display for displaying the execution of a wagering game. The handheld gaming machine wirelessly communicates with one or more of the plurality of boundary controllers to permit the central server to activate the wagering game only when the handheld gaming machine is within the permissible gaming area.

According to another aspect of the invention, a handheld gaming machine for displaying a wagering game includes a housing and a display mounted on the housing for displaying the wagering game. The handheld gaming machine further includes a power source for powering the display. The handheld machine includes a wireless transceiver operative to transmit and receive game play information. The wireless transceiver is configured to communicate with at least one boundary controller defining a permissible gaming area so as to disable display of the wagering game if the handheld machine is removed from the permissible gaming area.

According to yet another aspect of the invention, a method of conducting a handheld wagering game comprises issuing a player a handheld gaming machine for displaying the wagering game, the handheld machine including a display, a power source for powering the display, and a wireless transceiver. The method further includes receiving a wager from the player and verifying that the handheld machine is located within a permissible gaming area, the permissible gaming area defined by one or more boundary controllers in communication with the wireless transceiver, and if the handheld machine is within the permissible gaming area, enabling the wagering game on the handheld machine.

According to yet another aspect of the invention, a computer readable storage medium is encoded with instructions for directing a gaming machine to perform the above method.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a gaming machine embodying the present invention;

FIG. 2 is a block diagram of a control system suitable for operating the gaming machine;

FIG. 3 is a perspective view of a handheld gaming machine of the present invention; and

FIG. 4 is a diagram of a gaming system including a handheld gaming machine of FIG. 3.

FIG. 5 is a diagram of another gaming system including a handheld gaming machine in accord with at least some aspects of the present concepts.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

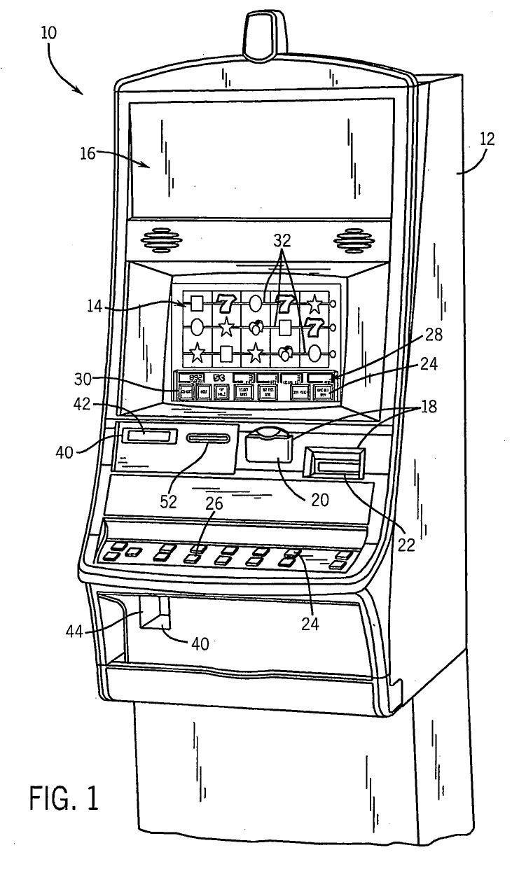

Referring to FIG. 1, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1). Alternatively, or in addition,. the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire monitor (or a portion thereof) to allow players to make game-related selections. Alternatively, the primary display 14 of the gaming machine 10 may include a number of mechanical reels to display the outcome in visual associated to at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1 as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52; which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

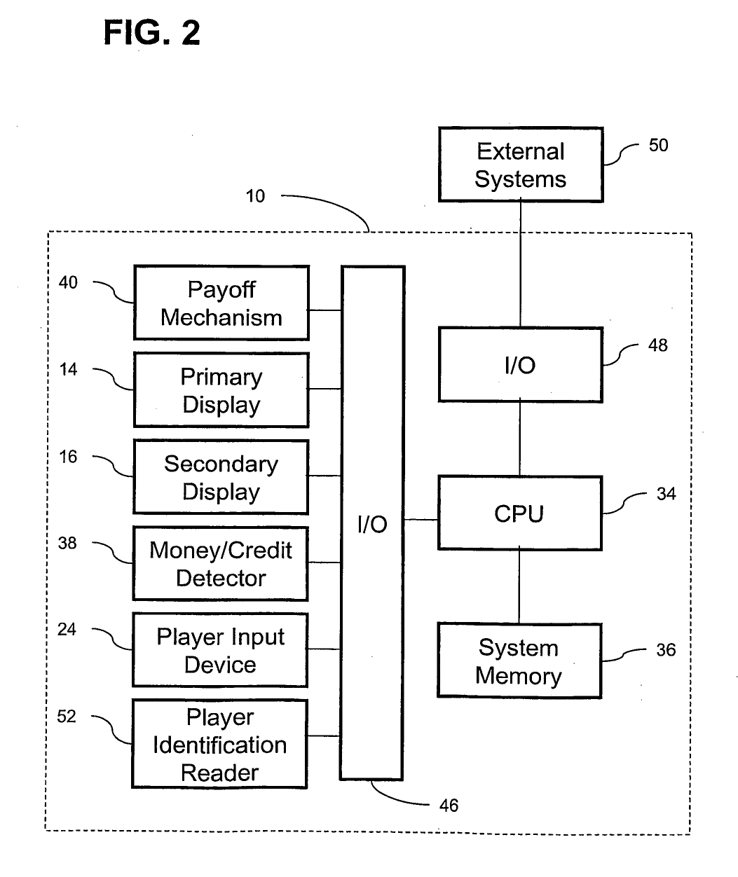

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36.

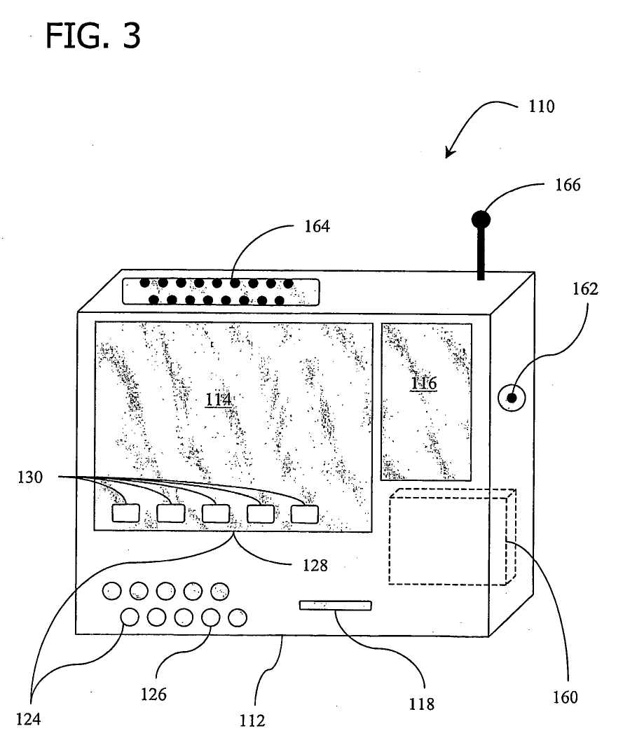

Turning now to FIG. 3, handheld gaming machine 110 is depicted, which includes some of the same components and features of the traditional freestanding gaming machine 10 described in relation to FIG. 1. As seen in FIG. 3, the handheld machine 110 includes a housing 112, a primary display 114, and various input devices including a value input device 118 and a player input device 124. As with the freestanding gaming machine 10, the primary display 114 of the handheld gaming machine 110 displays information about the basic wagering game played on the device 110, as well as information about bonus and progressive wagering games. Additional non-gaming information, such as casino or advertising information, may also be displayed via the primary display 114, or may be displayed on an optional secondary display 116 on the handheld machine 110. Preferably, the primary display 114 is a high resolution LCD display, but as with the freestanding machine 10, various displays may be used for both the primary and secondary displays 114,116.

As with the freestanding version, the value input device 118 may be provided in many forms. However, to ensure that the handheld machine 110 remains as light as possible and utilizes minimum power, the value input device 118 is preferably an information reader such as a ticket reader, barcode scanner, or card reader for reading information stored on a credit ticket, card, or other tangible credit storage account. The player input device 124 comprises a plurality of push buttons 126 and preferably a touch screen 128 mounted over the primary display 114 and/or secondary display 116. The touch screen 128 contains soft touch keys 130 denoted by graphics on the underlying primary display 114 and used to operate the handheld machine 110. The buttons 126 and touch keys 130 may be used to implement the same or differing functions. Like the freestanding machine 10, the handheld gaming machine 110 internally includes at least one processor (not shown) and computer readable storage in the form of system memory (not shown) connected to various internal and external peripherals via on or more input/output circuits.

As seen in FIG. 3, the handheld gaming machine 110 further includes several components additional components. The handheld machine 110 comprises a power source 160 such as a battery or fuel cell, an external power port 162, a docking port 164, and a wireless transceiver 166 for transmitting and receiving wireless communications. The power source 160 provides power to the handheld machine 110, to power the operation of the processor, the displays 114,116, and various other peripherals. Preferably, the power source 160 is configured to be rechargeable so that it may be restored to full power via an external power source, such as AC power. The external power port 162 receives and is connected to an external power source to operate the handheld machine 110 independently of the power source 160, while at the same time replenishing and charging the power source 160.

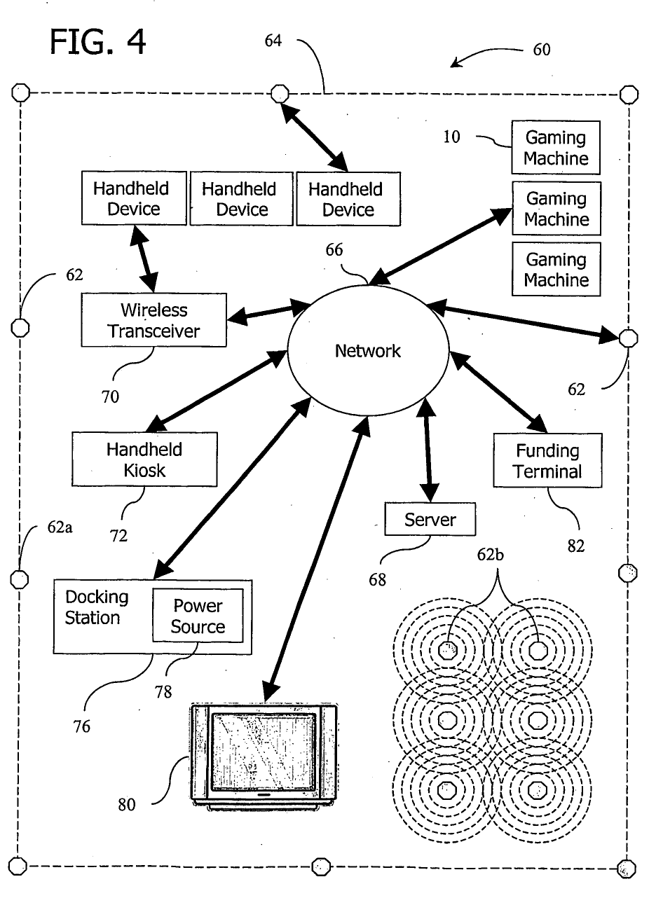

The docking port 164 is for receiving and connecting with a docking station 76 (see FIG. 4), which may be optionally included as part of a handheld gaming system 60 described herein. The docking port 164 may include an information connection for transmitting and receiving information via the handheld machine 110. The docking port 164 may optionally include a video port for transmitting video display information from the handheld gaming machine 110 to an external video display. Moreover, it should be understood that the rechargeable battery 160 may be recharged via a power input interfaced via the docking port 164. For example, the external power port 162 may be included in the docking port 164 such that when the handheld 110 is interfaced with a docking station 76, the battery 160 is charged via a power source included in the docking station 76. The docking port 164 may comprise a single physical connection as seen in FIG. 3, or may comprise a collection of multiple ports which are referred to collectively as a docking port 164.

The wireless transceiver 166 comprises one or more components which enable the handheld machine 110 to exchange information with a network of the handheld system 60. The wireless transceiver 166 may comprise and include, for example, an antenna, a wireless card, a Bluetooth™ connection, and an infrared connection, all of which transmit and receive information with outside sources. It should also be understood that the wireless transceiver 166 may include or incorporate wireless data transmitters and receivers of various configurations and specifications, and the term wireless transceiver 166 as used herein encompasses one or more of such devices collectively. Preferably the wireless transceiver 166 is in communication with the processor of the handheld machine 110 for purposes of exchanging game play information with the processor for play on the device 110. It should be understood that the wireless transceiver 166 may include a plurality of wireless communication components for exchanging information with two or more systems. For example, the transceiver 166 may include a wireless network card for transmitting and receiving game play information from a server 66 (see FIG. 4) of a game system, as well as an antenna for transmitting location information of the handheld machine 110 to one or more boundary controllers 62 (see FIG. 4) defining a permissible gaming area 64. One or more of these multiple components taken collectively comprise the wireless transceiver 166.

It should be understood that the handheld gaming machine 110 includes a unique identifier, signature, or other security information which may be transmitted wirelessly via the transceiver 166 to an external handheld gaming system 60 (see FIG. 4) to verify and authenticate the handheld machine 110 as being a permissible participant in the system 60. Any one of a variety of secure identification and authentication mechanisms may be used to perform such verification.

Preferably, a plurality of the handheld machines 110 are owned and operated by the casino operator and distributed to players throughout the casino for use in game play. However, the handheld machines 110 may be devices purchased by players and brought to a participating casino, where the devices 110 may be registered and configured for use therein. For example, the handheld machine 110 may comprise other personal devices such as cellular telephones, pagers, and personal daily assistants, that are further configured to act as the handheld machine 110 in cooperation with the system 60 described herein.

Turning to FIG. 4, a handheld gaming system 60 is depicted, which includes and supports one or more of the handheld gaming machines 110. The system 60 is preferably located within a casino, and includes a plurality of handheld machines 110, a plurality of freestanding gaming machines 10, and a plurality of boundary controllers 62 which define a permissible gaming area 64. Preferably the freestanding gaming machines 10 are linked together via a network 66, which includes one or more servers 68 for administering gaming and casino functions to the various gaming machines 10,110 in the system 60. The system may also include one or more wireless transceivers 70 in communication with the server 68 for wirelessly communicating with the handheld machines 110. The system 60 may optionally include one or more handheld kiosks 72 for dispensing and receiving handheld machines 110. The system 60 may optionally include one or more docking stations 76 for physically connecting with the handheld gaming machines 110. Preferably the docking stations 76 include a power source 78 for powering the handheld machines 110 and recharging the battery 160 of a docked device 110. The system 60 may also include one or more community displays 80 for displaying community gaming information. The community displays 80 may be in communication with the docking stations 76, network 66, and/or wireless transceivers 70 for receiving display information from individual freestanding or handheld gaming machines 10,110. The system 60 may optionally include one or more funding terminals 82, preferably located within the permissible gaming area 64, for purpose of inputting value into the handheld gaming machines 110 and optionally receiving value or “cashing out” a handheld machine 110 when play is completed.

In one preferred embodiment, the boundary controllers 62 comprise electronically wirelessly linked boundary controllers 62a which form a boundary, fence, or perimeter which comprises the permissible gaming area 64. The boundary controllers 62a may be configured to create a continuous, closed perimeter (as seen in FIG. 4) or may be used to create individual, non-continuous barriers at specific locations within the casino, such as physical entries and doorways into and out of the permissible gaming area 64. In another embodiment, the boundary controllers 62 comprise radiating boundary points 62b which emit a signal over a predetermined radial distance to define a portion of the permissible gaming area 64. Thus, a plurality of radiating boundary points 62b may work cooperatively to define a portion of the permissible gaming area 64 as seen in FIG. 4. In yet another embodiment, the linked boundary controllers 62a and radiating boundary points 62b work cooperatively to define portions of a complete permissible gaming area 64. It should be understood that the boundary controllers 62 may be mounted or located in various portions of the casino, utilizing various methods. For example, the linked boundary controllers 62a may be mounted on the walls, ceiling, gaming machines 10 or other devices in the casino, and may be hidden from view. Furthermore, the radiating boundary controllers 62b may be mounted on one or more other devices already within the casino or permissible gaming area 64, including freestanding gaming machines 10, funding terminals 82, docking stations 76 and kiosks 72.

Preferably, the various boundary controllers 62 are in communication with the network 66, and in wireless communication with the handheld machines 110 within the permissible gaming area 64. In this way, the boundary controllers 62 monitor the borders of the permissible gaming area 64 to ensure that no handheld machines 110 are operated outside of the permissible gaming area 64. In one embodiment, when the boundary controllers 62 detect that a handheld machine 110 has crossed out of the permissible gaming area 64, the boundary controllers 62 signal the server 68 over the network 66. The server 68 then deactivates the handheld gaming machine 110 entirely so as to be inoperable outside of the permissible gaming area 64. In another embodiment, the server 68 deactivates only the gaming functions on the handheld gaming machine 110, but permits other non-gaming functions to continue on the device 110 after it is removed from the permissible gaming area 64. In another embodiment, the wagering games are conducted on the central server 68 and the server 68 disqualifies a handheld gaming machine 110 from participating when the device 110 is removed from the permissible gaming area 64. In yet another embodiment, when the boundary controllers 62 detect the handheld machine 110 leaving the permissible gaming area 64, the gaming machine 110 changes from executing games using real money or currency, to executing games for fin using “play” money or points. The play money or points may be optionally exchanged by the player for hotel or casino services, entertainment, food, prizes, etc.

It should be further understood that the permissible gaming area 64 may be divided into two or more distinct areas, or zones, so as to permit various configurations. The subdivided areas may, for example, be in distinct portions of the casino facility. Alternatively, the subdivided permissible gaming areas 64 may be adjacent or adjoining, but may be configured to permit play of only certain types of gaming machines 110 in each subdivided area, or may permit play of only certain varieties of games within each subdivided area. The zones may be configured in a casino such that different zones activate different operability in the handheld machine 110. Moreover, some of the zones may be designated as temporary allowable zones to permit the handheld machine 110 to be temporarily removed from the permissible gaming area 64 without completely deactivating gaming functions. For example, restrooms in the casino may be designated as temporary allowable zones so as to permit players of the handheld machines 110 to enter temporarily without deactivating the device 110. The temporary allowable zones may be configured with one or more boundary controllers 62 or other transmitting devices so as to block or refuse gaming activity or transmissions on the handheld 110 until the device 110 is removed from the temporary allowable zone. Moreover, an indicator may be placed in the temporary allowable zone or on the handheld 110 to indicate that the device 110 needs to be removed or that it will be deactivated.

The network 66 may comprise a plurality of components forming an information network for transmission of data between the components connected to the network, including the server 68, the handheld machines 110, the free standing gaming machines 10, etc. Preferably, the network 66 includes both wired and wireless communications, which vary depending upon the type of component connected to the network 66. It should also be understood that the term network 66 as used herein encompasses one or more networks collectively utilized within the casino location. For example, the network 66 may comprise a plurality of distinct networks 66 performing various functions such as non-gaming functions, game play functions, administrative functions, and maintenance functions.

The server 68 manages game play and communicates with the various gaming machines 10,110 in the system 60 via the network 66. The server 68 may also comprises two ore more server devices which perform various functions. However, the term “server” 68 as used herein encompasses one or more of the servers on the system 60 collectively. Various servers may be used to perform various tasks, including execution of game play, non-gaming casino functions, administrative and maintenance functions.

The wireless transceivers 70 of the system 60 may be mounted in various locations of the casino so as to be configured to communicate with the handheld gaming machines 110. Specifically, the wireless transceivers 70 of the system 60 communicate with at least the wireless transceiver 166 on the handheld gaming machine 110. Preferably the transceivers 70 are located within range of the permissible gaming area 64, but transceivers 70 may be placed outside of the permissible gaming area 64 to communicate with handheld machines 110 outside of the area 64 performing permissible non-gaming functions. It should be understood that the wireless transceivers 70 may be configured to be distinct and separate wireless communications devices from boundary controllers 62. Thus, the boundary controllers 62 communicate boundary information to and from each other and the handheld gaming machines 110 to ensure that gaming occurs only in the permissible gaming area 64, while the wireless transceivers 70 communicate game-related information to and from the handheld machines 110 in the system 60. However, in an alternate embodiment, the functions of the boundary controller 62 and wireless transceiver 70 may be combined into a single wireless communication device. In such a configuration, the plurality of boundary controllers 62 would also serve as wireless transceivers to communicate gaming information to and from the handheld machines 110 in the system 60.

The docking stations 76 may be positioned in various locations throughout the permissible gaming area 64. Preferably the docking stations 76 include an external power source 78 for powering and recharging the handheld machines 110. The docking stations 76 are preferably located where seating is available in the casino, such as in a lounge, bar, restaurant, or other gaming area. A person playing a handheld gaming machine 110 may then physically connect the device 110 to a docking station 76 via the docking port 164. Once docked with the docking station 76, the handheld machine 110 may be offered a variety of various features not available when the device 110 is mobile, or undocked. For example, a docked gaming machine 110 may have its battery 160 charged by the external power source 78. Moreover, the docked gaming machine 110 may establish direct wired communications with other components of the system 60, such as the server 68, or the community display 80. In this way, for example, game play on a docked gaming machine 110 may be improved, such as by way of permitting the handheld machine 110 to transmit gaming information to be displayed on a larger community display 80. The docking station 76 may also permit the docked handheld machine 110 to communicate to one or more external systems via the network 66, such as hotel reservations, entertainment services, email, or Internet.

It should be understood that game play determinations may be made locally on the gaming machine 10, 110 or may be made centrally on the server 68. To maximize security, preferably game play determinations and generation of random outcomes of the game are performed on the server 68, the results of which are transmitted wireless to the handheld machine 110, and then displayed on the display 112, as described herein. Furthermore, it should be understood that a combination approach may be utilized. For example, freestanding gaming machines 10 which communicate with the network 66 through a wired connection may utilize local determination of game outcomes while handheld gaming machines 10 communicating with the network 66 wirelessly may utilize central determination of game outcomes on the server 68. Moreover, game outcome determination may depend on which game is played on the device, rather than the type of gaming machine 10, 110. In yet another embodiment, individual games may be locally determined while group play (community games, shared experiences, competitive or collaborative play) games are centrally determined on the server 68. Many different configurations are possible utilizing a combination of locally and centrally determined outcomes for game play.

The handheld gaming system 60 and device 110 are configured to provide a number of security options and funding options to permit safe, secure gaming. With respect to security, the handheld machine 110 may be locked and unlocked using any number of known electronic security measures including passwords, player identification devices, biometric devices, etc. For example, a player of the handheld machine 110 may register a password or biometric identifier upon initiating play of the handheld 110, and may be required to reenter such security identifier at various points during game play. Alternatively, the player may be issued a secondary identification device which permits game play on the handheld 110 while the secondary device remains in wireless communication with the handheld 110. In one embodiment, a biometric identifier comprises a fingerprint sensor which is located within either the buttons 126 or soft keys 130 of the handheld machine 110. In this embodiment, each time a player provides an input through the buttons 126 or soft keys 130, the sensor scans the fingerprint of the player and verifies his or her identify as an authorized user prior to acting on the button's input. For example, a “Spin” button may include the sensor to scan the fingerprint of a player executing a play of the game on the handheld machine 110 and ensure that the player pressing the Spin button is the player who's funds and account are activated on the machine. The fingerprint biometric against which the scanned fingerprint is compared may be either stored securely in the handheld machine 110, or may be stored externally in communication with the network 66 and server 68, and may be retrieved for comparison by the device 110. These and other security measures ensure that the player of the handheld machine 110 is the same as the player who has added value, or input funds into the device 110 for play.

The handheld machine 110 may be funded with money using a variety of different techniques. For example, the device 110 may be coupled to a funding terminal 70 where a player may add value using a bank account, credit card account, or other financial account. Alternatively, the device 110 may communicate over the network 66 with a player financial account stored on the server 68, or elsewhere. The finding terminals 70 may be configured to accept currency and transfer such value to the handheld machine 110. Conversely, the funding terminals 70 may be coupled to a device 110 for purposes of cashing out the device 110, and may credit a player financial account, or dispense cash to the player. Any number of other well known credit techniques may be employed for funding and/or cashing out value via the handheld machine 110, including tickets, cards, Smartcards, etc. Furthermore, the handheld machine 110 may be configured so as to be linked to other player accounts and transfer value between the device 110 and such account.

In addition to the components of the system 60 described with relation to FIG. 4, various audio visual indicators and signs may be used to provide information relating to the system to players in the casino. For example, the handheld kiosks 72, funding terminals 82 and docking stations 76 may be provided with signage and instructions to inform players as to their nature and location, and how they are operated.

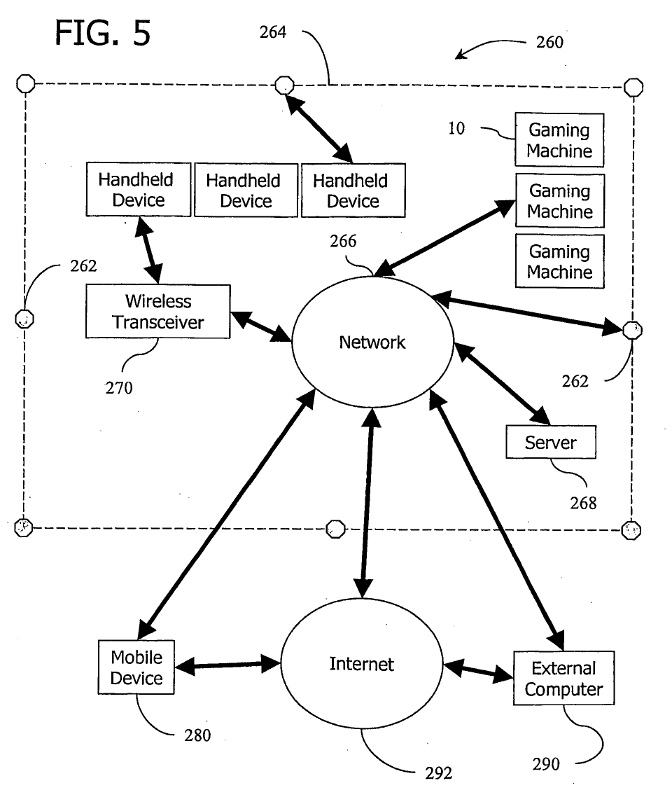

In FIG. 5, an alternate embodiment of the system 260 is shown, which includes a number of components enabling handheld gaming both inside and outside of the casino. The system 260 includes a server 268, a network 266, a plurality of freestanding gaming machines 10, a plurality of handheld machines 210, one or more mobile devices 280, and one or more external computers 290 in communication with an internet network 292. The freestanding gaming machines 10 and handheld machines 210 are operation within a casino to execute and display wagering games. Preferably, as before, the handheld machines 210 are only operable within a permissible gaming area 264 defined by one or more boundary controllers 262. The handheld machines 210 communicate with the server 268 and network 266 wirelessly by communicating through wireless transceivers 270 located within the casino. The mobile devices 280 and external computers 290 are operable to execute wagering games outside of the casino (outside of the permissible gaming area 264). The mobile devices 280 wirelessly communicate over the network 266 with the server 268, or alternatively via the internet network 292. The mobile devices 280 include any number of wireless portable communications devices including mobile telephones, pagers, handheld computers, and personal daily assistants.

The external computers 290 communicate with the server 268 either via the network 266 in the casino (if in range of the wireless transceivers 270), or alternatively through the internet network 292. The computers 290 may include any number of computing devices including laptop computers, desktop computers, notebooks, personal computers, or other processor driven computing devices. The internet network 292 may include one or more wired or wireless connections to permit communication between the computers 290 and the server 268 in the casino. This allows the computers 290 to exchange game information with the server 268 over the world wide web. It should be understood that the various gaming machines 10, 210, 280, 290 in the system 260 may be configured to execute game play locally, or simply display the results of games executed remotely on the server 268. Furthermore, the system 260 may be configured so as to permit downloadable gaming. In such a configuration, a variety of games may be downloaded from the server 268 to one or more of the gaming machines 10, 210, 280, 290, either through player selection, or operator/casino configuration. The network 266 and internet 292 may also be used for administrative and maintenance functions such as downloading operating system software updates, patches, etc.

The handheld gaming system 60 described herein may be configured in many ways to provide new and entertaining gaming options within a casino. For example, the handheld machine 110 may be configured to play a game having multiple episodes, stages, or events which require the collection of various game assets, combinations, prizes, etc. Coupled with the portability of the handheld machine 110, the game may require the player to acquire certain assets in one portion of the gaming floor (the permissible gaming area 64) and then move on to collect different assets in another portion of the gaming area 64. In this way, the casino operator may utilize the handheld machine 110 to cause players to physically move and explore different portions of the casino while playing a “treasure hunt” type game.

In another embodiment, the system 60 may be configured so that certain gaming machines 10 and handheld machines 110 in certain portions of the permissible gaming area 64 may be adjusted during certain time periods to provide better payouts, or play “looser” by providing a higher expected value return to the player. In this way, the system 60 may include geographically located “specials” which may be advertised to players in the casino either audibly or visually. Such promotions may be configured by the casino operator by adjusting the configuration of the system 60 at various points in time.

In yet another embodiment, the system 60 may be configured so that the handheld machine 110 permits a player to play a game normally played in a bank of freestanding gaming machines 10 when the bank is full. For example, if a traditional bank of gaming machines 10 may be geographically located nearby one another for purposes of advertisement or playing some form of linked community game amongst two or more of the machines 10 in the bank. A player holding a handheld machine 110 who wishes to play in the bank may be permitted to do so. The player's ability to join in the bank game may be conditioned upon him being located within a certain distance or range of the bank. Thus, a player may use his handheld gaming machine 110 to play a bank or community game which is otherwise fill. Moreover, the handheld gaming machine 110 may be configured to permit the play of a casino-wide community game regardless of the location of the player and the handheld machine 110 within the permissible gaming area 64. Such casino-wide community games may be played on only the handheld machines 110 in the casino, only the free standing gaming machines 10 in the casino, all gaming machines 10 and devices 110 collectively, or any combination thereof.

In yet another embodiment, the handheld gaming machine 110 and the system 60 may be configured so that a player playing on handheld machine 110 may accumulate or “bank” bonus games which he or she has successfully won or achieved, rather than playing the bonus game. For example, the handheld gaming machine 110 may store the banked bonus games in memory for play at a later time. The player may then interface the handheld machine 110 with a freestanding gaming machine 10 or a community display 80 in the system 60 for play of the bonus games. In this way, the player may bank and save his or her earned bonus game awards for play at a later time on a device having improved graphics, display, or other audio visual qualities. The bonus games may alternatively be banked or stored on the system 60, in the server 68 or other device on the network 66, and later retrieved by the player at a different gaming machine 10 or community display 80 for improved display during execution.

The handheld gaming machines 110 of the system 60 may also be configured to be utilized with table games or other wagering games in the casino. The table games could include real table games or virtual table games executed and displayed on various displays within the casino. For example, a player with a handheld gaming machine 110 may be permitted to place wagers on a traditional table game, for example a roulette wheel game. The player utilizes the handheld machine 110 to place his wager on the table game, and then standing near the table, watches the outcome of the game. If he is a winner, the player may be either awarded traditional physical chips from the table, or may alternatively be credited electronically through the handheld machine 110. The table games and/or other wagering games may be configured, for example, with wireless transceivers 70 to communicate with the handheld machines 110, so as to receive wagering information and handle debiting and crediting of player accounts as wagering and game play occurs. Furthermore, the table games and/or other wagering games may also be configured with a boundary device 62, such as one or more radiating boundary points 62b to detect the presence of a handheld machine 110 within a certain predefined range of the table game and thus permit such device 110 to wager on the game. In this way, the handheld machine 110 and the system 60 may be used to improve the speed of table game wagering, as well as permit more players to wager on a given table game by eliminating the need to physically place wagers on the table. The handheld machine 110 may include a layout, map or virtual casino floor to depict the locations and varieties of various table games within the casino. Moreover, the player need not be present at the table to view the outcome of the table game. Instead, the outcome of one or more table games may be displayed to the player on the display 114 of the handheld machine 110. For example, outcomes of various table games may be broadcast through videostreaming to the handheld machines 110 of players participating in the table games.

The handheld kiosks 72 of the system 60 may be configured so as to serve as either pickup kiosks or drop-off kiosks such that a player entering the casino may acquire a handheld machine 110 from a pickup kiosk 72 in order to play. The player would then electronically register and fund the handheld machine 110 over the network 66 or at one or more funding terminals 82 in the casino. Registration of the handheld machine 110 may include the use of a security obligation such as a cash or credit deposit, lien, etc. to ensure the return of the device 110 at the conclusion of gaming. The player may register the handheld machine 110 using one or more registration methods such as passwords, biometric inputs, player tracking devices, and other techniques described herein. The player commences game play on the handheld machine 110 and continues for as long as he or she wishes (while in the permissible gaming area 64). At the conclusion of a gaming session, the player may simply return the handheld machine 110 to a drop-off kiosk 72 located in the casino. The drop-off kiosks 72 may be configured so as to automatically receive the returned device 110, remove any security obligations (deposits, liens, etc.), and credit the player's electronic accounts with wagering money remaining in the funded device 110.

The system 60 may also be configured so that various games are organized into distinct geographical areas of the casino, and comprises gaming lounges or “cafes.” The server 68 and network 66 may be configured so as to permit any number of players bearing handheld machines 110 to dynamically enter or leave the game play within a gaming café. Such cafes represent distinct geographical areas within the permissible gaming area 64. Thus each café may be configured to play one or more games of a particular theme or group of themes. Preferably each café includes at least a portion of game play which is a community game, such as competitive, collaborative, group or shared outcome gaming. The server 68 may be configured to dynamically manage the entry into the group game played in the café.

Furthermore, the handheld machines 110 of the system 60 may be configured to provide any number of non-gaming services. For example, the handheld machine 110 may provide maps of the casino floor and permissible gaming area 64. The devices 110 may provide directions, arrows, or route finders to a player walling through the casino by utilizing one or more of the boundary devices 62 and/or wireless transceivers 70 as locating devices to position the handheld machine 110 within the casino. The combination of the boundary devices 62 and wireless transceivers 70 may be configured so as to provide geographic triangulation so as to dynamically locate individual handheld machines 110 within the casino. Moreover, the maps on the devices 110 may provide locations of gaming elements (such as funding terminals 82, docking stations 76, kiosks 72, etc.) as well as non-gaming elements in the casino such as restaurants, bars, stairs, elevators, shops, etc.

The system 60 may also be configured so as to incorporate any number of peripheral devices to work in conjunction with the handheld machines 110 on the network 66. For example, the casino may employ a variety of cameras, microphones, webcams, etc. located throughout the casino. The audio/visual content captured by such peripheral devices may be retrieved via the handheld machine 110. Moreover, the peripherals may be located on the devices 110 so that each handheld machine 110 includes a webcam and microphone. This permits, for example, communications between players possessing handheld machines 110 for an improved gaming experience. Numerous other peripherals, including telephones, video displays, and other entertainment may be employed by the system 60 and provided to players via the handheld machine 110.

Consistent with the above, in at least some configurations, the players are permitted to define their own network (e.g., a “peer-to-peer” network) or selective association between gaming machines 10 and/or handheld gaming machines 110, such as through an application layer. In such a player-defined network space, the gaming machine(s) 10 and/or handheld gaming machine(s) 110 would display, or could be enabled to display, a list of other gaming machines (e.g., 10, 110) participating in a game activity or a non-game activity. A player may then select one or more of the other gaming machines (e.g., 10, 110) and communicate with the players of such gaming machines using any form of inter-machine communication including, but not limited to text messaging, instant messaging, e-mail, visual communication, and/or voice communication. Moreover, a player may also select one or more of the other gaming machines (e.g., 10, 110) to link game play between the machines, preferably (but not necessarily) following communication with the player at that machine and mutual agreement to link game play. Optionally, linkage of game play requires agreement of both (or all) parties to the linkage. In one example, a player may send an “Accept linkage” button or command and/or a “Deny linkage” button or command to a selected one or more of the other gaming machines (e.g., 10, 110). One the linkage is established, any manner of group play such as, but not limited to, cooperative play or competitive play is available to the players.

To facilitate game play with known players, a player is permitted to designate certain gaming machines (e.g., 10, 110), addresses associated therewith, or addresses associated with those known players, as a “friend” on a “friends list.” The friends list then displays which players from a predefined list of players are currently playing on a network-connected wagering game machine (e.g., 10, 110). As other players associated with the friends list begin playing on a network-connected wagering game machine, a notification message is automatically sent to the player and the friends list is updated.

The handheld gaming machine 110 and system 60 of the present invention offer a number of benefits over traditional gaming machines. The portability of the device 110 allows longer play times as players may engage in other activities such as eating, drinking, socializing, or exercising while playing the device 110. The portability of the devices 110 also promotes more social gaming opportunities as compared to the solitary nature of remaining at a freestanding gaming machine. Moreover, the portability of the handheld machine 110 permits casino operators to encourage movement by players about the casino and allows players to see portions of casinos which they might not otherwise experience, thereby increasing income opportunities for casino operators. The synergistic value of permitting handheld 110 gaming in conjunction with other activities provides multiple opportunities for such casino operators to increase revenue while simultaneously providing a new, entertaining and enjoyable method of gaming for players.

The system memory 36 or computer readable storage medium of handheld gaming machine 110 may advantageously comprise a hard drive bearing a computer readable storage media bearing data such as, but not limited to, one or more game programs, applications, image data, and/or instruction sets. To preserve the integrity of such data against impacts which might occur during use of the handheld gaming machine 110, an impact protection system may advantageously be provided. The impact protection system comprises, in at least some aspects, a motion sensor (not shown) and an actuator (not shown). The motion sensor is configured to sense one or more conditions and output signals relating thereto to either an embedded controller, hard drive controller and/or controller 34, the controller being configured to process the signals and determine whether or not a situation that could potentially damage the hard drive exists or is about to exist. The controller (e.g., 34) then actuates an actuator such as, but not limited to, a spring or a voice coil, to place the hard drive in a safe or safer state.

The motion sensor comprises at least one accelerometer and preferably includes more than one accelerometer. In one aspect of the present concepts, the motion sensor comprises three micro-accelerometers arranged orthogonally to one another to enable continuous measurement of acceleration in three dimensions and output of signals relating to such acceleration to a handheld gaming machine 110 controller (e.g., 34) or communication device. Motion sensors which may be used in accord with the present concepts include, for example, the SQ-SEN-001P/1PS or SQ-SEN-003P/3PS/3PS-XL tilt and vibration sensors manufactured by SignalQuest of New Hampshire, a micro-machined and/or micro-electro-mechanical system (MEMS) such as model SQ-SI2X-360 series (e.g., 360° single-axis, 180° dual-axis, or 360°×180° dual-axis), also manufactured by SignalQuest, the 3DM-GX1 or the Inertia-Link wireless inertial sensor suite manufactured by Microstrain of Burlington, Vt., the MMQ50, MMQ-G GPS/INS sensors manufactured by BEI Systron-Donner of Concord, Calif., or accelerometer chips such as, but not limited to those manufactured by MEMSIC Inc. of Massachusetts or Analog Devices Inc., also of Massachusetts (e.g., the Analog Devices ADXL320 accelerometer chip, which is managed by an embedded controller).

In at least some aspects, the handheld gaming machine 110 motion sensor is configured to detect movement and/or rotation in three dimensions (i.e., about each of the x-axis, y-axis, and z-axis in an orthogonal Cartesian coordinate system or, for example in another coordinate system such as a skew coordinate system) and output a signal or signals corresponding to the sensed movement (e.g., acceleration) to a controller (e.g., 34). In some embodiments, the motion sensor comprises one or more sensors (e.g., a gyroscope) configured to measure rotational movement or accelerations.

If a predetermined set of conditions is met indicating the potential for damage to the hard drive is indicated by the signals output from the motion sensor(s), the controller outputs a signal to the actuator to place the hard drive and/or components associated therewith in a safe position or at least in a safer position. The signal output by the controller may arise from, but is not limited to, reference to a memory (e.g., a look-up table) or a hard-wired response to a predetermined output signal from the motion sensor (e.g., a threshold voltage output). The actuator is configured in turn, in at least one aspect, to move the read/write head(s) of the hard drive to a safety position to prevent or minimize the potential for damage to the disk drive from the read/write head(s). It is to be noted that a plurality of safety positions could also be provided such that the read/write head(s) can be moved to the closest available safety position as quickly as possible. For example, a first safety position could comprise a landing zone at or near an inner diameter of the disk where no data is stored and a second safety position could comprise at or near an outer diameter of the disk where no data is stored.

In still other aspects, a plurality of sensors and/or a plurality of actuators may be employed to enhance the ability of the sensor and actuator combination to protect the hard drive. For example, a signal from the sensor could simultaneously be used to actuate an actuator (e.g., a rotary actuator) to move the read/write head(s) of the hard drive to a safety position and to actuate a spindle brake or de-energize the spindle motor to slow and/or stop the rotation of the disk(s). Alternatively, the impact protection system may comprise one or more other types of sensors and/or switches (i.e., not accelerometers) to achieve the same end. For example, a variety of switches or sensors (e.g., capacitance, impedance, pressure, pressure skin array, etc.) may be positioned in the areas where a user would typically hold the handheld gaming machine 110, such as the sides, top, and bottom. In combination, other such switches or sensors are positioned in the areas of the handheld gaming machine 110 upon which a user would typically rest or set down the handheld gaming machine (e.g., on the bottom or back). Outputs from switches or sensors are, in at least some aspects, directed to a controller (e.g., 34) and, upon a predetermined combination of outputs, indicating a stated wherein the handheld gaming machine 110 appears not to be in contact with any surface, the controller actuates the actuator to protect the hard drive. Alternatively, the outputs from the sensors (e.g., with embedded controllers) and switches may be hardwired to a separate switch controlling the actuation of the actuator so that the appropriate confluence of outputs causes an automatic operation of the actuator.

The accelerometer(s) may further be used, in other embodiments, in combination with other types of sensors to prevent inadvertent actuators of the actuator to protect the hard drive. For example, in one aspect, one or more sensors are disposed about the sides of the handheld gaming machine 110, such as on handles provided therefore, to detect a condition associated with the touching or holding of the handheld gaming machine by a user (e.g., a temperature sensor, an impedance sensor, a capacitance sensor, etc.). The controller is configured only to actuate the actuator in the event of both an indication by the sensor(s) in the handle that the user is not holding or touching one or both of the handheld gaming machine 110 handles. Any variety of configurations of or combinations of different sensor and/or switch types are contemplated as falling within the disclosed concepts.

The user may be provided an option of selecting a desired sensitivity of the impact protection system (e.g., low, medium, high), so as to permit a user to avoid uninterrupted play despite low-level shocks (e.g., a low setting) or against even energetic or enthusiastic movement of the handheld gaming machine 110 (e.g., a high setting) during use. To minimize the potential for interruptions, however, a cache memory is advantageously used to temporarily store media data that will soon be accessed or is predicted to be soon accessed. With a suitably-sized cache memory, interruptions of the disk drive due to abrupt movements will be minimized. Software may also be installed in a memory on a memory device or firmware which may be configured to or which is configurable to facilitate adjustments to sensitivity of the impact protection system.

The controller (e.g., 34) is configured to resume normal operation and management of the hard drive when the signal or signals output by the motion sensor, or a corresponding lack of such signal or signals, indicate that there is no sensed damage-indicative or damage-predictive condition or event.

Each of these embodiments and obvious variations thereof is contemplated as falling within the spirit and scope of the claimed invention, which is set forth in the following claims. Moreover, aspects of the disclosed embodiments may be suitably used in applications and field outside of the disclosed field and applications. For example, the disclosed impact protection system may be used in combination with other types of portable electronic devices.

1. A gaming system comprising:
a central server for storing game information;
a plurality of boundary controllers defining a permissible gaming area; and
at least one handheld gaming machine in communication with the central server, the handheld machine comprising a display for displaying the execution of a wagering game;
wherein the handheld gaming machine wirelessly communicates with one or more of the plurality of boundary controllers to permit the central server to activate the wagering game only when the handheld gaming machine is within the permissible gaming area.

2. The gaming system of claim 1, wherein at least two of the boundary controllers are electronically linked to form a fence comprising the border of the permissible gaming area.

3. The gaming system of claim 1, wherein at least one of the boundary controllers is a radiating boundary controller, the radiating boundary controller emitting a point source wireless signal which defines a portion of the permissible gaming area.

4. The gaming system of claim 1 further comprising at least one freestanding gaming machine in communication with the central server.

5. The gaming system of claim 1, wherein the handheld gaming machine is in wireless communication with a wireless transceiver, the wireless transceiver in communication with the central server.

6. The gaming system of claim 1 further comprising at least one handheld kiosk for either dispensing or receiving the handheld gaming machine to a player, the kiosk in communication with the central server.

7. The gaming system of claim 1 further comprising at least one funding terminal for adding value to the handheld gaming machine, the funding terminal in communication with the central server.

8. The gaming system of claim 7, wherein the funding terminal accesses a player financial account stored on the central server, and debits the player financial account when adding value to the handheld machine.

9. The gaming system of claim 1 further comprising at least one docking station in communication with the central server, the docking station connectable to a docking port on the handheld machine.

10. The gaming system of claim 9, wherein the docking station includes a power source for charging a battery of the handheld machine.

11. A handheld gaming machine for displaying a wagering game, comprising:
a housing;
a display mounted on the housing for displaying the wagering game;
a power source for powering the display; and
a wireless transceiver operative to transmit and receive game play information, the wireless transceiver is configured to communicate with at least one boundary controller defining a permissible gaming area so as to disable display of the wagering game if the handheld machine is removed from the permissible gaming area.

12. The handheld machine of claim 11 further comprising a player input device for making game play selections.

13. The handheld machine of claim 11 wherein the player input device comprises at least one of a touch screen overlying the display and a button mounted on the housing.

14. The handheld machine of claim 11, wherein the power source comprises at least one of a battery and a fuel cell.

15. The handheld machine of claim 11 further comprising a docking port for coupling to a docking station, the docking station including a power source for charging the battery.

16. A method of conducting a handheld wagering game, the method comprising:
issuing a player a handheld gaming machine for displaying the wagering game, the handheld machine including a display, a power source for powering the display, and a wireless transceiver;
receiving a wager from the player;
verifying that the handheld machine is located within a permissible gaming area, the permissible gaming area defined by one or more boundary controllers in communication with the wireless transceiver; and
if the handheld machine is within the permissible gaming area, enabling the wagering game on the handheld machine.

17. The method of claim 16, wherein the game play is executed by a processor on the handheld gaming machine.

18. The method of claim 16, wherein the game play is executed on a central server, the server in communication with the wireless transceiver on the handheld gaming machine.

19. The method of claim 16, wherein the step of receiving a wager from the player comprises debiting a credit value on the handheld machine, the credit value funded by debiting a player financial account.

20. A computer readable storage medium encoded with instructions for directing a gaming machine to perform the method of claim 16.
